(19) United States
(12) Patent Application Publication
(10) Pub. No.: US 2014/0152900 A1
(43) Pub. Date: Jun. 5, 2014

(54) INFORMATION TERMINAL APPARATUS

(71) Applicant: Funai Electric Co., Ltd., Osaka (JP)

(72) Inventors: Kousuke HASHIMOTO, Daito-shi (JP); Kentaro KAJIHARA, Daito-shi (JP)

(73) Assignee: Funai Electric Co., Ltd., Osaka (JP)

(21) Appl. No.: 14/087,083

(22) Filed: Nov. 22, 2013

(30) Foreign Application Priority Data
Dec. 3, 2012 (JP) 2012-264083

(51) Int. Cl. H04N 5/445

(52) U.S. Cl. CPC H04N 5/445
USPC 348/734

(57) ABSTRACT

An information terminal apparatus which suppresses a user's having a disconcerting experience with a display action on a display unit accompanying the operation of devices is provided. This information terminal apparatus includes: a communication unit which transmits a state acquisition request signal and also receives a response signal from a DMR in response to the state acquisition request signal and also which transmits a command signal to the DMR based on operation directions of the user and also receives a response signal from the DMR in response to the command signal; a display unit which displays the state of the DMR based on each of the received response signals; and a control unit which performs control such that the state of the DMR after the change is displayed on the display unit based on the response signal without being disturbed by the display action based on the response signal.

### BACKGROUND OF THE INVENTION

1. Field of the Invention

This invention relates to an information terminal apparatus and particularly to an information terminal apparatus comprising a communication unit that performs communications with devices to be operated and a display unit that displays the state of the devices to be operated.

2. Description of the Related Art

Information terminal apparatuses comprising a communication unit that performs communications with devices to be operated and a display unit that displays the state of the devices to be operated have been known in the past (for example, see Japanese Translation of PCT International Application 2004-531172).

The aforementioned Japanese Translation of PCT International Application 2004-531172 discloses an integrated remote controller apparatus (information terminal apparatus) constituted so as to be able to individually control [each of] a plurality of electronic devices (devices to be operated) that are connected to a network via a home network system constructed in accordance with IEEE 1394 and other standards. This integrated remote controller apparatus comprises an input unit from which a user inputs specified command signals, a send/receive unit that sends the command signals input from the input unit to the electronic device and also receives response signals from the electronic device, and a display unit that displays the content of operations with respect to the electronic device and also displays the state of action of the electronic device based on the response signals in cooperation with the action of the send/receive unit.

### SUMMARY OF THE INVENTION

With the integrated remote controller apparatus described in the aforementioned Japanese Translation of PCT International Application 2004-531172, after the electronic device is made to act (operated) based on the command signals sent from the send/receive unit to the electronic device (device to be operated), there is no disclosure or suggestion of details of the content of control at the time of display on the display unit of the state of action (the results of operation) of the electronic device based on the response signals received again via the send/receive unit. Accordingly, after the user uses this integrated remote controller apparatus (information terminal apparatus) to operate the electronic device, there is a possibility that the display content sent to the display unit based on the response signals from the electronic device may not appear in the proper form (the timing of display, etc.). For example, there are conceivable cases in which the content of communications normally exchanged between the information terminal apparatus and the electronic device and the content of the response from the electronic device in response to sudden operation of the device by the user (the results of the state of the electronic device being altered accompanying the user's operation of the device) are displayed on the display unit in a commingled and confused state. In this case, there is a risk of the content of the response accompanying the user's operation of the device being displayed on the display unit at improper timing in addition to the normal content of communications. For this reason, there is a problem in that the display action on the display unit accompanying the operation of the device may be disconcerting to the user.

This invention was devised in order to solve the aforementioned problems, and one object of this invention is to provide an information terminal apparatus with which it is possible to suppress the user having a disconcerting experience with respect to the display action on the display unit accompanying the operation of devices.

The information terminal apparatus according to one aspect of this invention comprises: a communication unit which periodically transmits a state acquisition request signal for acquiring the state of a device to be operated and also periodically receives a first response signal from the device to be operated in response to the state acquisition request signal and also which transmits a command signal to the device to be operated based on the operation directions of the user and also receives a second response signal from the device to be operated in response to the command signal; a display unit which displays the state of the device to be operated based on each of the first response signals and the second response signal received by the communication unit; and a control unit which, at the time of displaying on the display unit the state of the device to be operated that was changed based on the operation directions by the user, performs control such that the state of the device to be operated after the change is displayed on the display unit based on the second response signal without being disturbed by the action of displaying on the display unit the state of the device to be operated based on the first response signal.

As was described above, with the information terminal apparatus according to the one aspect of this invention, by providing a control unit which, at the time of displaying on the display unit the state of the device to be operated that was changed based on the operation directions by the user, performs control such that the state of the device to be operated after the change is displayed on the display unit based on the second response signal without being disturbed by the action of displaying on the display unit the state of the device to be operated based on the first response signal, it is possible to appropriately display, in the information terminal apparatus, the state of the device to be operated after the change based on the second response signal that is received accompanying the user operation without being affected by the display action on the display unit based on the periodically received first response signal. To wit, the display action on the display unit corresponding to the first response signal and the display action on the display unit corresponding to the second response signal are not commingled, so the user can correctly recognize the display action on the display unit corresponding to the second response signal without being confused with the display action on the display unit corresponding to the first response signal. As a result, it is possible to suppress the user having a disconcerting experience with respect to the display action on the display unit accompanying the user's operation of the device.

In the information terminal apparatus according to the aforementioned one aspect, the control unit is preferably constituted so as to perform a first control which gives priority to receiving the second response signal from the device to be operated in response to the command signal and also to displaying on the display unit the post-change state of the device to be operated based on the second response signal over displaying on the display unit the state of the device to be operated based on the periodically received first response signal, thereby performing control such that the post-change state of the device to be operated is displayed on the display unit based on the second response signal without being disturbed by the action of displaying on the display unit the state of the device to be operated based on the first response signal. If such a constitution is adopted, because the first control is performed in the information terminal apparatus, it is possible to easily and reliably perform control so as to display the post-change state of the device to be operated based on the second response signal that is received accompanying the user operation without being affected by the display action on the display unit based on the periodically received first response signal.

In the information terminal apparatus according to the aforementioned one aspect, the control unit is preferably constituted so as to perform a second control which adjusts the reception interval of the first response signals that are periodically received by the communication unit rather than displaying on the display unit the state of the device to be operated based on the periodically received first response signal, thereby performing control such that the post-change state of the device to be operated is displayed on the display unit based on the second response signal without being disturbed by the action of displaying on the display unit the state of the device to be operated based on the first response signal. With such a constitution, as a result of the second control being performed in the information terminal apparatus, it is possible to easily and reliably perform control so as to display the post-change state of the device to be operated based on the second response signal that is received accompanying the user operation without being affected by the display actions on the display unit based on the periodically received first response signal.

In a constitution in which the first control is performed by the aforementioned control unit, the first control preferably includes control such that the post-change state of the device to be operated is displayed on the display unit based on the second response signal without being disturbed by the action of displaying on the display unit the state of the device to be operated based on the first response signal by preventing the state of the device to be operated based on the periodically received first response signal from being displayed on the display unit during the period from when the command signal is sent to the device to be operated until the second response signal is received by the communication unit. If such a constitution is adopted, when the state of the device to be operated is changed accompanying the user operation and the need arises to receive the second response signal which includes the content of this change (the results of the change), the display contents based on the periodically received first response signals will not be reflected at all on the display unit, so it is possible to reliably display on the display unit of the information terminal apparatus only the content of the change (the results of the change) based on the second response signal.

In this case, the first control preferably includes control such that the state of the device to be operated based on the periodically received first response signal is prevented from being displayed on the display unit by halting the control of sending any of the state acquisition request signals to the device to be operated during the period from when the command signal is sent to the device to be operated until the second response signal is received by the communication unit. With such a constitution, when the state of the device to be operated is changed accompanying the user operation and the need arises to receive the second response signal which includes the content of this change (the results of the change), the control itself of sending the state acquisition request signals to the device to be operated, which is the basis for receiving periodic first response signals, will be halted, so it is possible to reduce the burden related to periodic communications between the information terminal apparatus and the device to be operated. Accordingly, it is possible to reliably receive the second response signal in a situation in which the communication state is not confused and to reliably display on the display unit of the information terminal apparatus only the content of the change (the results of the change) based on the second response signal.

In a constitution in which the second control is performed by the aforementioned control unit, it is preferable that the reception interval of the first response signals periodically received by the communication unit be a reception interval of a second length of time which is longer than a first length of time as the response time from when any of the state acquisition request signals is sent to the device to be operated until the corresponding one of the first response signals is received by the communication unit and also as the response time from when the command signal based on the operation directions by the user is sent to the device to be operated until the second response signal is received by the communication unit, and that the second control include control so as to display on the display unit the post-change state of the device to be operated based on the second response signal without being disturbed by the action of displaying on the display unit the state of the device to be operated based on the first response signal by securing the reception interval such that the first length of time from when the command signal by the user is sent to the device to be operated until the second response signal is received by the communication unit is kept within the second length of time. If such a constitution is adopted, the first length of time as the response time required for the reception of the second response signal based on user operations is sufficiently short in comparison to the reception interval of the first response signals which is set as the second length of time so as to fit within the second length of time, so even if the state of the device to be operated is changed with the user operation and the need arises to receive the second response signal which includes the content of this change (the results of the change), it is possible to receive the second response signal by utilizing the time band (timing) within the second length of time during which no first response signal is received and to reliably display on the display unit of the information terminal apparatus the content of the change (the results of the change) based on the second response signal on the display unit.

In this case, it is preferable that the constitution be such that a communication network is constructed by the information terminal apparatus and the device to be operated, and that the second length of time as the reception interval be set so as to be longer than the first length of time which includes the communication time required for the sending and receiving of the command signal or the second response signal between the information terminal apparatus and the device to be operated in the communication network and the processing time required for the processing of the command signal or the second response signal on the side of the device to be operated. With such a constitution, the second length of time as the reception interval is set so as to be longer than the first length of time which takes into consideration the processing capacity of the device to be operated in the environment in which the communication network is constructed; therefore, even with such a first length of time, it can be reliably kept within the second length of time. Accordingly, even if a small amount of lag arises in the timing of the reception of the second response signal caused by the processing capacity of the device to be operated, it is possible to reliably display on the display unit of the information terminal apparatus the content of the change (the results of the change) based on the received second response signal on the display unit without being disturbed by the action of displaying on the display unit the state of the device to be operated based on the first response signal.

In the information terminal apparatus according to the aforementioned one aspect, the control unit is preferably constituted so as to perform control such that at the time of displaying on the display unit the state of at least the audio volume, the audio quality, or the video brightness of the device to be operated that was changed based on the operation directions by the user, at least the audio volume, the audio quality, or the video brightness of the device to be operated after the change is displayed on the display unit based on the second response signal without being disturbed by the action of displaying on the display unit the state of at least the audio volume, the audio quality, or the video brightness of the device to be operated based on the first response signal. In the information terminal apparatus, if such a constitution is adopted, it is possible to appropriately display the post-change state of at least the audio volume, the audio quality, or the video brightness of the device to be operated based on the second response signal that is received accompanying user operation without being affected by the display action on the display unit regarding the state of at least the audio volume, the audio quality, or the video brightness of the device to be operated based on the periodically received first response signal. Consequently, it is possible to suppress the user having a disconcerting experience with respect to the display action on the display unit related to the audio volume, the audio quality, or the video brightness of the device to be operated.

In the information terminal apparatus according to the aforementioned one aspect, it is preferable that the information terminal apparatus and the device to be operated be a digital media controller and a digital media renderer, respectively, each of which has received device certification by the DLNA and which can recognize the other by performing mutual communications via the home network, and that the control unit be constituted so as to perform control such that at the time of displaying on the display unit the state of the digital media renderer that was changed based on the operation directions of the digital media controller by the user, the state of the digital media renderer after the change is displayed on the display unit based on the second response signal without being disturbed by the action of displaying on the display unit of the digital media controller the state of the digital media renderer based on the first response signal. With such a constitution, in a home network constituted by at least a digital media controller and a digital media renderer, when the user operates the digital media renderer via the digital media controller, there is no commingling of the display action on the display unit of the digital media controller corresponding to the first response signal and the display action on the display unit corresponding to the second response signal, so the user can correctly recognize the display action on the display unit of the digital media controller corresponding to the second response signal without being confused with the display action on the display unit of the digital media controller corresponding to the first response signal. Accordingly, it is possible to suppress the user having a disconcerting experience with respect to the display action on the display unit accompanying the operation of the digital media controller.

With the present invention, as was described above, it is possible to suppress the user having a disconcerting experience with respect to the display action on the display unit accompanying the user's operation of the device.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a model diagram showing the constitution of a home network comprising the DMC (digital media controller) according to a first preferred embodiment of the present invention.

FIG. 2 is a block diagram showing the respective device configurations of the DMC, a DMR (digital media renderer), and a DMS (digital media server) in the home network according to the first preferred embodiment of the present invention.

FIG. 3 is a diagram for illustrating the time sequence regarding the communications between the DMC and the DMR when the DMC according to the first preferred embodiment of the present invention is used to change the volume level that is output from the DMR.

FIG. 4 is a flowchart for illustrating the control of communications between the DMC and the DMR when the DMC according to the first preferred embodiment of the present invention is used to change the volume that is output from the DMR.

FIG. 5 is a diagram for illustrating the time sequence regarding the communications between the DMC and the DMR when the DMC according to a second preferred embodiment of the present invention is used to change the volume that is output from the DMR.

FIG. 6 is a flowchart for illustrating the control of communications between the DMC and the DMR when the DMC according to the second preferred embodiment of the present invention is used to change the volume that is output from the DMR.

FIG. 7 is a diagram for illustrating the time sequence regarding the communications between the DMC and the DMR when the DMC according to a third preferred embodiment of the present invention is used to change the volume that is output from the DMR.

FIG. 8 is a diagram for illustrating the time sequence regarding the communications between the DMC and the DMR when the DMC according to a modified example of the third preferred embodiment of the present invention is used to change the volume that is output from the DMR.

### DETAILED DESCRIPTION OF THE PREFERRED EMBODIMENTS

Preferred embodiments of the present invention will be described below based on drawings.

### First Preferred Embodiment

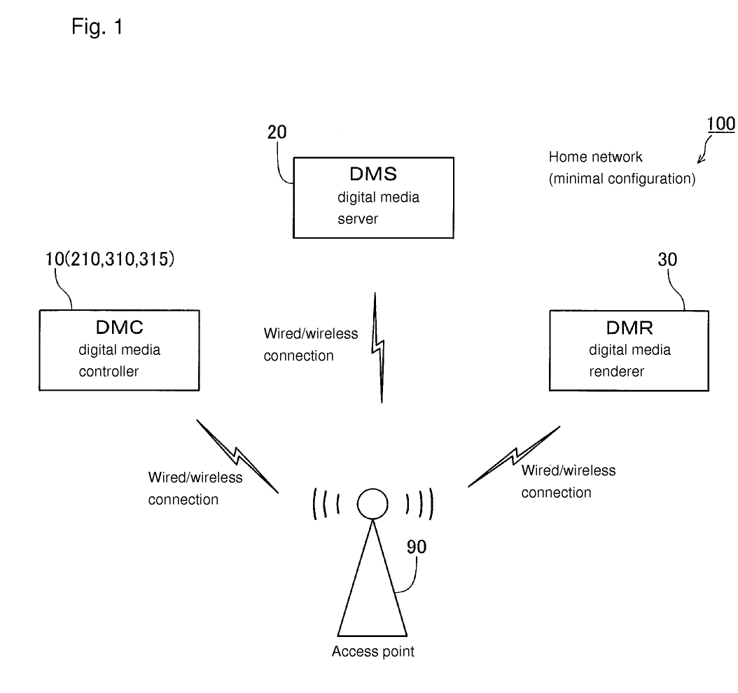

First, the constitution of the DMC (digital media controller) 10 according to a first preferred embodiment of the present invention will be described with reference to FIGS. 1 through 3. Note that the DMC 10 is one example of the “information terminal apparatus” and “digital media controller” of the present invention.

As is shown in FIG. 1, in a home network 100 using the DMC 10 according to the first preferred embodiment of the present invention, the DMC 10, a DMS (digital media server) 20, and a DMR (digital media renderer) 30 are disposed in a state in which mutual communications are possible with wires or without wires (wirelessly) via an access point 90. Here, the DMC 10, DMS 20, and DMR 30 are DLNA Certified™ devices that have received device certification by the DLNA (Digital Living Network Alliance). For example, a portable information terminal (smartphone (multi-function mobile phone)) may be used as the DMC 10, while a BD recorder may be used as the DMS 20. Furthermore, a digital television set is used as the DMR 30. As long as they are electronic device products based on the DLNA Guidelines, wireless or wired interconnection is possible regardless of the manufacturer or type of device, so it is possible to realize the exchange of digital content among electronic devices. Note that the DMR 30 is one example of the “device to be operated” and “digital media renderer” of the present invention.

Accordingly, in the following description, the description given will assume the case of using the DMC 10 to select the videos, music, still images, or other digital content stored in the DMS 20 and outputting this digital content from the DMR 30. The constitution is such that for example, after the user selects music content stored in the DMS 20 by using the DMC 10, this music content can be output from the DMR 30. Moreover, in this case, the constitution is such that it is possible to use the DMC 10 to appropriately change (adjust) the volume, sound quality, video brightness, and various other output values for the digital content being output from the DMR 30. Here, in FIG. 1, for simplicity of description, the constitution of the home network 100 is illustrated showing only a single unit each of the DMC 10, DMS 20, and DMR 30. To wit, a plurality of access points 90 may be present, and a plurality of DMSs 20 and a plurality of DMRs 30 may also be connected to each of the plurality of access points 90 or to the single access point 90.

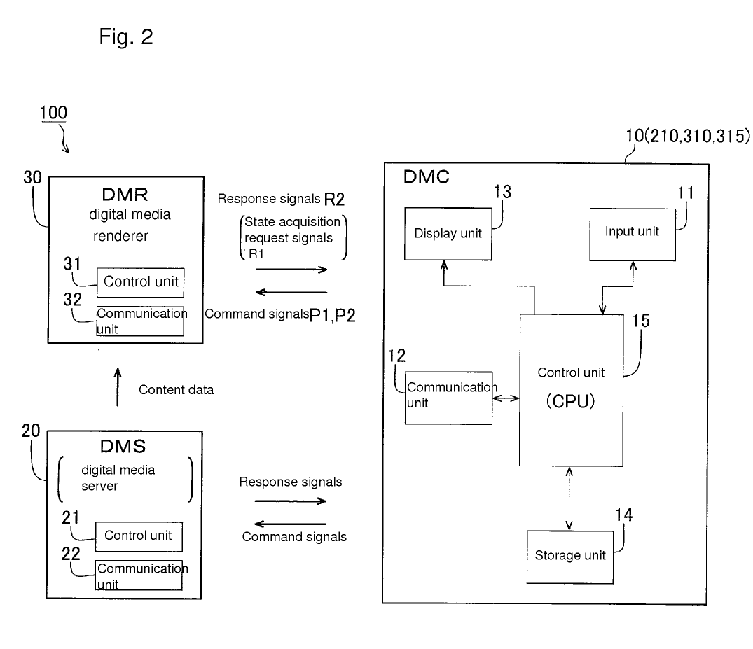

The DMC 10 comprises an input unit 11, a communication unit 12, a display unit 13, a storage unit 14, and a control unit 15 as shown in FIG. 2.

The input unit 11 is composed of operation buttons (operation keys) and a touch panel and receives operation directions from the user regarding the operation of devices. For example, the input unit 11 is constituted such that while music content is being output (being played) from the DMR 30, a command signal P2 (e.g., a volume set command, etc.) which changes the volume level can be input by the user at arbitrary timing to the DMC 10 from the input unit 11. The communication unit 12 has the function of sending (issuing) the command signal P2 (volume set command) received via the input unit 11 to the DMR 30 and also receiving from the DMR 30 a response signal R2 to the effect that the volume was changed on the side of the DMR 30 based on the command signal P2. Note that the command signal P2 is one example of the “command signals” of the present invention. In addition, the response signal R2 is one example of the “second response signal” of the present invention.

The display unit 13 has the function of displaying the state of the DMR 30 (the volume, sound quality, video brightness, and various other output levels in the DMR 30 at that time) specified based on the response signal R2 received by the communication unit 12. Furthermore, the input unit 11 and the display unit 13 are disposed on the surface of the cabinet (not shown) constituting the DMC 10, while the communication unit 12 is built into the interior of the DMC 10.

The storage unit 14 has the function of storing a time-series history of the command communications (command signals P2 and response signals R2) between the DMC 10 and the DMR 30. Moreover, the control unit 15 is constituted by a CPU and has the function of taking control of the aforementioned various constituent elements (the input unit 11, communication unit 12, and display unit 13) of the DMC 10 by executing a control program stored in the storage unit 14.

In addition, as is shown in FIG. 2, the DMR 30 is also provided with a control unit 31 and a communication unit 32 that receives control commands (command signals P2) from the DMC 10 based on the control of the control unit 31 and also sends its own state of action to the DMC 10 as response signals R2. Furthermore, the DMS 20 is also provided with a control unit 21 and a communication unit 22 that receives control commands (command signals at the time of selecting content, etc.) from the DMC 10 based on the control of the control unit 21 and also sends its own state of action to the DMC 10, in addition to sending content data (such as music content data) to the DMR 30.

As a result of each of the devices (DMC 10, DMS 20, and DMR 30) that make up the home network 100 (see FIG. 1) having the aforementioned constitution, while music content is being output at the DMR 30, communications with each other as follows are periodically conducted between the DMC 10 and the DMR 30.

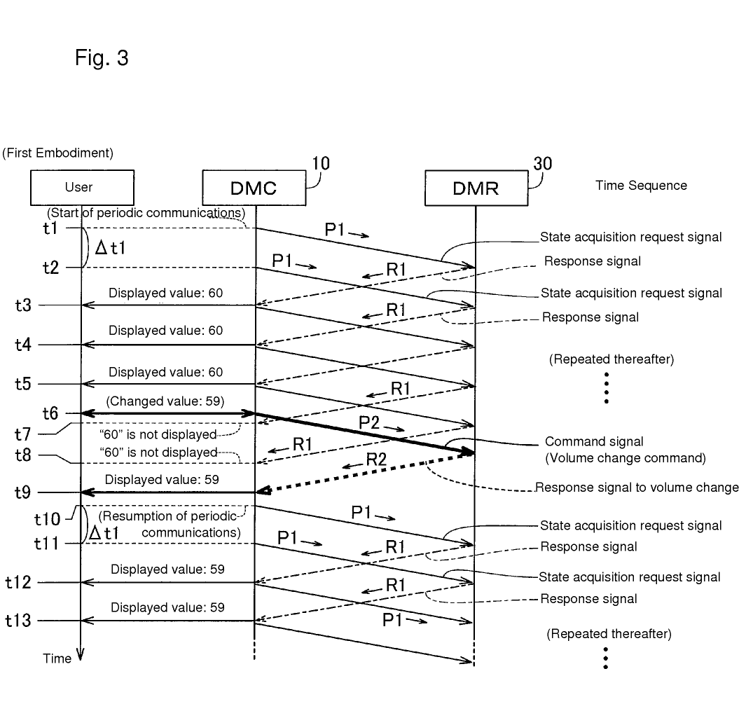

In concrete terms, as is shown in FIG. 3, the constitution is such that state acquisition request signals P1 (solid-line arrows) for acquiring the state of the DMR 30 are sent from the communication unit 12 of the DMC 10 (see FIG. 2) to the DMR 30 at time intervals of a time Δt1 (=time t2−time t1), and also response signals R1 (one-dot chain arrows) in response to state acquisition request signals P1 are received by the communication unit 12, and thus one round-trip of communications is repeated periodically (at an interval of a time Δt1).

Specifically, in the situation of communications between the DMC 10 and the DMR 30, first at the timing of time t1, a state acquisition request signal P1 is sent from the DMC 10 to the DMR 30, and also at the timing of time t3, a response signal R1 from the DMR 30 is received by the communication unit 12. Moreover, at the timing of time t2, a time Δt1 after time t1, the next state acquisition request signal P1 is sent from the DMC 10 to the DMR 30, and also at the timing of time t4, the next response signal R1 from the DMR 30 is received by the communication unit 12. In this manner, at time intervals of the time Δt1, state acquisition request signals P1 are successively sent from the DMC 10 to the DMR 30, and the respective responding response signals R1 from the DMR 30 are received by the communication unit 12. Note that this control of periodic communications from the DMC 10 to the DMR 30 is the state in which “periodic communication control mode” is performed. Note that the response signals R1 are one example of the “first response signals” of the present invention.

In the situation in which the aforementioned “periodic communication control mode” is performed by the DMC 10, let us say that, for example, the user changes the volume level of the music content being listened to. Specifically, the user performs the operation of changing (lowering) the volume level of the DMR 30 by using their finger or the like to operate the input unit 11 of the DMC 10 at the sudden (sporadic) timing of time t6 as shown in FIG. 3.

In this case, let us say that at time t6, a command signal P2 (bold solid-line arrow) for lowering the volume level by just one level from the current “60” to “59” is sent from the DMC 10 to the DMR 30 based on the operation directions of the user. In the DMR 30, based on the command signal P2 received by the communication unit 32 (see FIG. 2), the action of lowering the volume level from the current “60” to “59” is performed under the control of the control unit 31 (see FIG. 2). Then, control is immediately performed so as to send (reply with) a response signal R2 (bold dashed arrow) for displaying on the display unit 13 of the DMC 10 the fact that the post-change volume level is “59.” Thereby, control is performed at the DMC 10 so as to receive the response signal R2 at a timing of the time t9 and also display on the display unit 13 based on the response signal R2 the state that the post-change volume level of the DMR 30 is “59.”

Here, in the first preferred embodiment, the constitution is such that when displaying on the display unit 13 the fact that the post-change volume level of the DMR 30 is “59” at the timing of the time t9, the following control is performed by the control unit 15 (see FIG. 2): Specifically, the control unit 15 is constituted so as to perform control such that at the time of displaying on the display unit 13 of the DMC 10 the state of the DMR 30 (the fact that the volume level was changed to “59”) that was changed based on the operation directions of the DMC 10 by the user, rather than displaying on the display unit 13 the state of the DMR 30 (the fact that the volume level was “60” before the change) based on response signals R1 that are received periodically (two times) from the DMR 30 at the respective timings of time t7 and time t8 after time t6, priority is given to the act of displaying on the display unit 13 the post-change state of the DMR 30 (the fact that the volume level was changed to “59”) based on the response signal R2 received from the DMR 30 in response to the command signal P2 at a timing of the time t9 after these times t7 and t8. Note that the aforementioned control of giving priority to display action based on the response signal R2 is one example of the “first control” of the present invention.

Thus, between the DMC 10 and the DMR 30, the “periodic communication control mode” which had been the execution mode up until then is halted at the timing of the time t6, and a temporary shift is made to the “user operation mode” which gives priority to the display action based on the response signal R2. In this “user operation mode,” the control unit 15 does not display on the display unit 13 the state of the DMR 30 prior to the change (the fact that the volume level was “60” before the change) based on the response signals R1 received at the timing of the times t7 and t8.

In other words, in the first preferred embodiment, the control unit 15 is constituted so as to perform control in the “user operation mode” such that at the time of displaying on the display unit 13 of the DMC 10 the state of the DMR 30 (the fact that the volume level was changed to “59”) that was changed based on the operation directions of the DMC 10 by the user, the state of the DMR 30 that was changed based on the response signal R2 is displayed on the display unit 13 of the DMC 10 without being disturbed by the action of displaying on the display unit 13 of the DMC 10 the state of the DMR 30 based on response signals R1 due to periodic communications. Thereby, in the DMC 10, the constitution is such that after the volume level is changed from “60” to “59” by the command signal P2 accompanying the operation of the device by the user, the display of the volume level of “60” based on the response signals R1 up until then will not be displayed (reflected) at all on the display unit 13, but rather the volume level “59” which will be the state of the DMR 30 after the change based on the response signal R2 will be displayed so as to react instantly to the operation of the device by the user.

In addition, in the first preferred embodiment, as is shown in FIG. 3, the constitution is such that in the aforementioned control of giving priority to display actions based on the response signal R2, during the period from when the command signal P2 is sent to the DMR 30 at the timing of time t6 until the response signal R2 is received by the communication unit 12 at the timing of time t9 (during the period in which the “user operation mode” continues), the control of sending state acquisition request signals P1 to the DMR 30, which should be done periodically if in the normal “periodic communication control mode,” is halted here. That is, no new state acquisition request signals P1 are generated during the period from time t6 to time t9 in FIG. 3. Thus, the constitution is such that if the state of the DMR 30 is changed such that the volume level goes from “60” to “59” as a result of the user using the DMC 10 to operate the device at time t6, and there arises the need to receive the response signal R2 which includes the result of this change at the timing of time t9, then the control itself of sending to the DMR 30 the state acquisition request signals P1, which is the basis for receiving the periodic response signals R1, is halted temporarily during the period from time t6 to time t9. This lessens the burden related to periodic communications between the DMC 10 and the DMR 30 (the sending and receiving of state acquisition request signals P1 and response signals R1) during the period from time t6 to time t9.

Note that as is shown in FIG. 3, the constitution is such that after time t9, the volume level is “59,” so at each timing at time t10 and thereafter, a state acquisition request signal P1 is again sent from the communication unit 12 (see FIG. 2) to the DMR 30 (see FIG. 2) at a time interval of time Δt1 (=time t11−time t10), and response signals R1 responding to the state acquisition request signals P1 are received by the communication unit 12, thus periodic repetitions (at an interval of the time Δt1) of such one round-trip of communications are resumed. To wit, the DMC 10 returns the mode from the “user operation mode” to the original “periodic communication control mode.” Accordingly, the volume level of “59” is displayed on the display unit 13 at the timing of time t12 based on the response signal R1 in response to the state acquisition request signal P1 sent at a timing of time t10. Furthermore, the volume level of “59” is displayed on the display unit 13 at the timing of time t13 based on the response signal R1 in response to the state acquisition request signal P1 sent at a timing of time t11.

Moreover, in the first preferred embodiment, the constitution is such as to perform control such that not only in the aforementioned case of changing the volume level, but also at the time of displaying on the display unit 13 the audio quality, video brightness, or other states of the DMR 30 that are changed based on operation directions by the user, the mode is temporarily shifted from “periodic communication control mode” to “user operation mode,” and the post-change state of the sound quality, video brightness, or the like of the DMR 30 is displayed on the display unit 13 based on the response signal R2 without being disturbed by the action of displaying on the display unit 13 the state of the sound quality, video brightness, or the like of the DMR 30 based on the response signals R1 accompanying periodic communications. Thus, the constitution is such that the same control as in the aforementioned case of changing the volume level is performed in regard to the display of all output levels from the DMR 30 that can be changed (adjusted) with the DMC 10. Control is performed in this manner regarding the mutual communications between the DMC 10 and the DMR 30 that make up the home network 100 according to the first preferred embodiment.

Next, the flow of processing of the control unit 15 of the DMC 10 when the DMC 10 is used to operate the DMR 30 in the first preferred embodiment will be described with reference to FIGS. 2 through 4. Note that in the following description, an example used to describe the control action of the DMC 10 involves the case in which the operation of the device by the user (the operation of the device with respect to the DMR 30 for the purpose of changing the volume level of music content being listened to) occurs during periodic repetitions of control of communications in which state acquisition request signals P1 are sent from the communication unit 12 (see FIG. 2) of the DMC 10 (see FIG. 2) to the DMR 30 (see FIG. 2) at a time interval of the time Δt1 (see FIG. 3) and also response signals R1 are received by the communication unit 12.

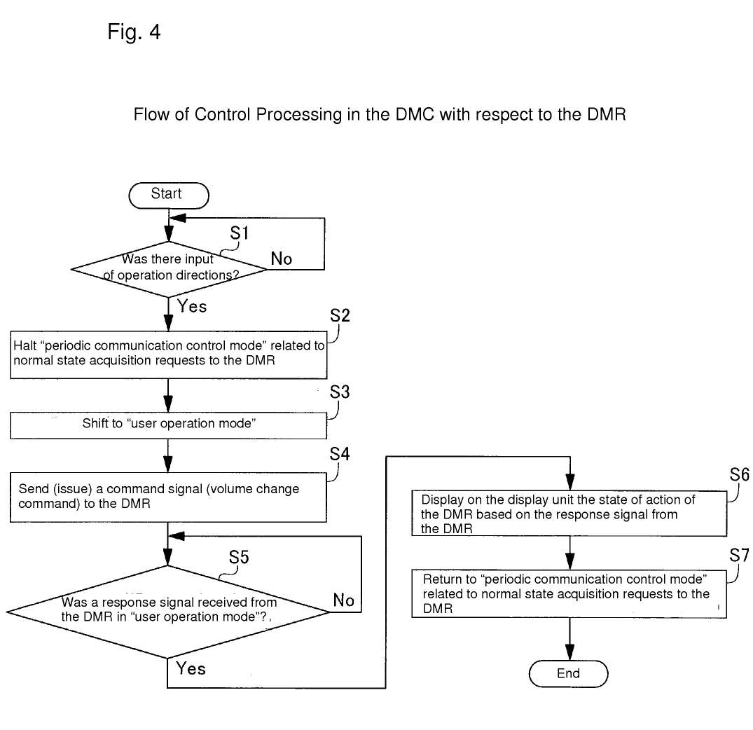

As is shown in FIG. 4, first in Step S1, the control unit 15 (see FIG. 2) determines whether or not directions to operate the DMC 10 (see FIG. 2) were input from the input unit (see FIG. 2) by the user, and this determination is repeated until it is determined that directions to operate the DMC 10 were input from the input unit 11 by the user. This determination in Step S1 is performed repeatedly at a specified timing at time t1 and thereafter in the time sequence of FIG. 3.

Here, as is shown in FIG. 3, it is assumed that at the timing of time t6, a command signal P2 (bold solid-line arrow) for lowering the volume level by just one level from the current “60” to “59” is sent from the DMC 10 to the DMR 30 based on the user operation directions. In this case, in Step S1, a determination is made (a determination of Yes) that directions to operate the DMC 10 were input from the input unit 11 by the user. Consequently, in Step S2, the control unit 15 temporarily halts the “periodic communication control mode,” which is the action of periodically sending and receiving state acquisition request signals P1 and response signals R1 performed between the DMC 10 and the DMR 30 (see FIG. 2). Then, in Step S3, control is performed so as to shift to “user operation mode.”

Then, in Step S4, in “user operation mode,” a command (command signal P2) corresponding to the operation directions accepted by the input unit 11 (operating the device so as to change the volume level of the music content) is sent (issued) to the DMR 30 at the timing of time t6 (see FIG. 3).

Then, in Step S5, the control unit 15 determines whether or not a response signal R2 has been received from the DMR 30, and this determination is repeated until a determination is made that a response signal R2 was received from the DMR 30.

If it is determined in Step S5 that a response signal R2 from the DMR 30 in response to the command signal P2 was received at the timing of time t9 (see FIG. 3), then in Step S6, control is performed such that the post-change state of the DMR 30 that the volume level is “59” is immediately displayed on the display unit 13 based on the response signal R2. To wit, the “periodic communication control mode” is halted in the DMC 10 as shown in FIG. 3, so the fact that the volume level before the change had been “60” based on the response signals R1 that are received periodically (two times) from the DMR 30 at the respective timings of time t7 and time t8 is not displayed at all on the display unit 13. Then, in this state, the post-change volume level of the DMR 30 of “59” is displayed on the display unit 13.

Afterwards, in Step S7, the “periodic communication control mode” that was temporarily halted in Step S2 is resumed. That is, the DMC 10 returns the mode from the “user operation mode” which had been executed during the period over Steps S3 through S6 to the normal “periodic communication control mode.” Accordingly, the volume level “59” based on the response signal R1 responding to the state acquisition request signal P1 sent at the timing of time t10 is displayed on the display unit 13 at the timing of time t12, and also this control of communications (“periodic communication control mode”) is repeated thereafter. This control is terminated in this manner in the DMC 10.

In the first preferred embodiment, as was described above, the DMC (digital media controller) 10 and the DMR (digital media renderer) 30 are electronic devices that have each received device certification by the DLNA and that can recognize each other by performing mutual communications via the home network 100. In addition, the control unit 15 is provided which, at the time of displaying on the display unit 13 of the DMC 10 the state of the DMR 30 that the volume level, for example, was changed from “60” to “59” based on directions by the user to operate the DMC 10, performs control (=“user operation mode”) so as to display on the display unit 13 of the DMC 10 the state of the DMR 30 after the volume level is changed to “59” based on the response signal R2, without being disturbed by the action (=“periodic communication control mode”) of periodically displaying on the display unit 13 of the DMC 10 the state of the DMR 30 (the fact that the volume level was “60”) based on the response signals R1 up until then. Consequently, in the DMC 10, it is possible to appropriately display the post-change state of the DMR 30 (the state that the volume level was changed to “59”) based on the response signal R2 received accompanying the user operation without being affected by the display action (the action of continuing to display the volume level of “60”) on the display unit 13 based on the periodically received response signals R1. That is, the periodic action of displaying on the display unit 13 of the DMC 10 corresponding to the response signals R1 in “periodic communication control mode” are not commingled with the transient display action on the display unit 13 of the DMC 10 corresponding to the response signal R2 in “user operation mode,” so the user is not confused by the display action on the display unit 13 corresponding to the response signals R1, but rather can be correctly made aware of the display action which indicates “59” without delay, showing that the volume level was changed from “60” to “59.” As a result, it is possible to suppress the user having a disconcerting experience with respect to the display action on the display unit 13 of the DMC 10 accompanying the operation of the device by the user.

In the first preferred embodiment, furthermore, the control unit 15 is constituted so as to perform control such that by performing control which gives priority to receiving a response signal R2 from the DMR 30 in response to a command signal P2 and also to displaying on the display unit 13 the state of the DMR 30 after the change based on the response signal R2 (the actions in “user operation mode” of displaying without delay the display value being from “60” to “59” accompanying the change in the volume level) over displaying on the display unit 13 the state of the DMR 30 based on periodically received response signals R1 (the action in “periodic communication control mode” of continuously displaying the volume level of “60”), the post-change state of the DMR 30 is displayed on the display unit 13 based on the response signal R2 without being disturbed by the action of displaying on the display unit 13 the state of the DMR 30 based on the response signals R1. Thereby, in the DMC 10, by performing the aforementioned control which gives priority to display actions based on the response signal R2, it is possible to easily and reliably perform control so as to display the post-change state of the DMR 30 based on the response signal R2 that is received accompanying user operations without being affected by the display actions on the display unit 13 based on the periodically received response signals R1.

Moreover, in the first preferred embodiment, the aforementioned control that gives priority to display actions based on the response signal R2 includes control such that by not displaying on the display unit 13 the state of the DMR 30 based on the periodically received response signals R1 during the period from when the command signal P2 is sent to the DMR 30 until the response signal R2 is received by the communication unit 12, the post-change state of the DMR 30 is displayed on the display unit 13 based on the response signal R2 without being disturbed by the action of displaying on the display unit 13 the state of the DMR 30 based on the response signals R1. Consequently, when the state of the DMR 30 is changed with the user operation and the need arises to receive the response signal R2 which includes the content of this change (the results of the change), none of the display content whatsoever based on the periodically received response signals R1 is reflected on the display unit 13, so it is possible to reliably display on the display unit 13 of the DMC 10 only the content of the change (the results of the change) based on the response signal R2.

In addition, in the first preferred embodiment, the aforementioned control that gives priority to display actions based on the response signal R2 includes control such that by halting the control of sending state acquisition request signals P1 to the DMR 30 during the period from when the command signal P2 is sent to the DMR 30 until the response signal R2 is received by the communication unit 12, the state of the DMR 30 based on the periodically received response signals R1 is not displayed on the display unit 13. Consequently, when the state of the DMR 30 is changed with the user operation and the need arises to receive the response signal R2 which includes the content of this change (the results of the change), the control itself of sending the state acquisition request signals P1 to the DMR 30, which is the basis of receiving the periodic response signals R1, is halted, thus lessening the burden related to periodic communications between the DMC 10 and the DMR 30 (the sending and receiving of state acquisition request signals P1 and response signals R1). Accordingly, it is possible to reliably receive the response signal R2 in a situation in which the state of communications is not confused and to reliably display on the display unit 13 of the DMC 10 only the content of the change (the results of the change) based on the response signal R2.

Furthermore, in the first preferred embodiment, the control unit 15 is constituted so as to perform control such that when not only the audio volume of the DMR 30 that is changed based on operation directions by the user but also the audio quality, video brightness, or other states of the DMR 30 are displayed on the display unit 13, the post-change state of the DMR 30 such as the audio quality or the video brightness is displayed on the display unit 13 based on the response signal R2 without being disturbed by the action of displaying on the display unit 13 the state of the DMR 30 such as the audio quality or video brightness based on the response signals R1. Consequently, in the DMC 10, it is possible to appropriately display the post-change state of at least the audio volume, audio quality, or video brightness of the DMR 30 based on the response signal R2 received accompanying user operation without being affected by the action of displaying on the display unit regarding the state of at least the audio volume, audio quality, or video brightness of the DMR 30 based on the periodically received response signals R1. This makes it possible to suppress the user having a disconcerting experience with respect to the display action on the display unit 13 related to the audio volume, audio quality, or video brightness of the DMR 30.

### Second Preferred Embodiment

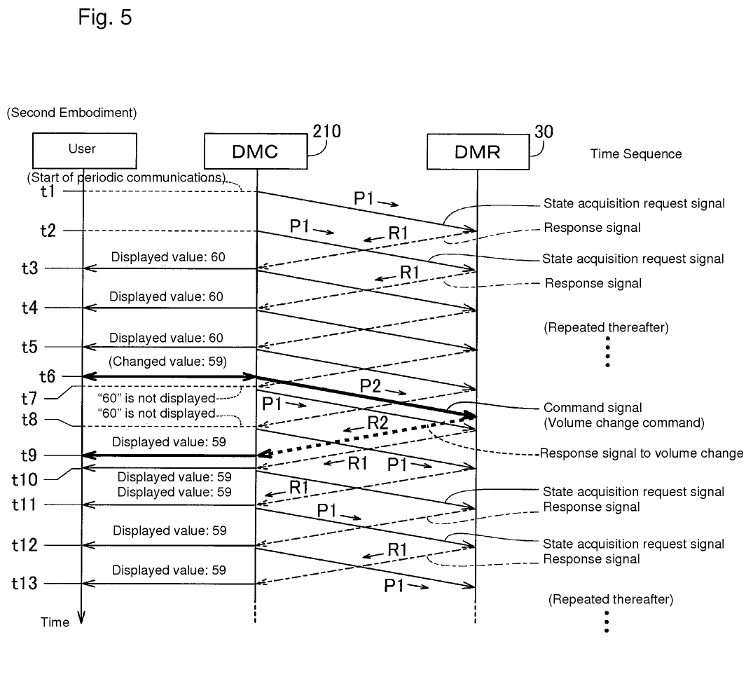

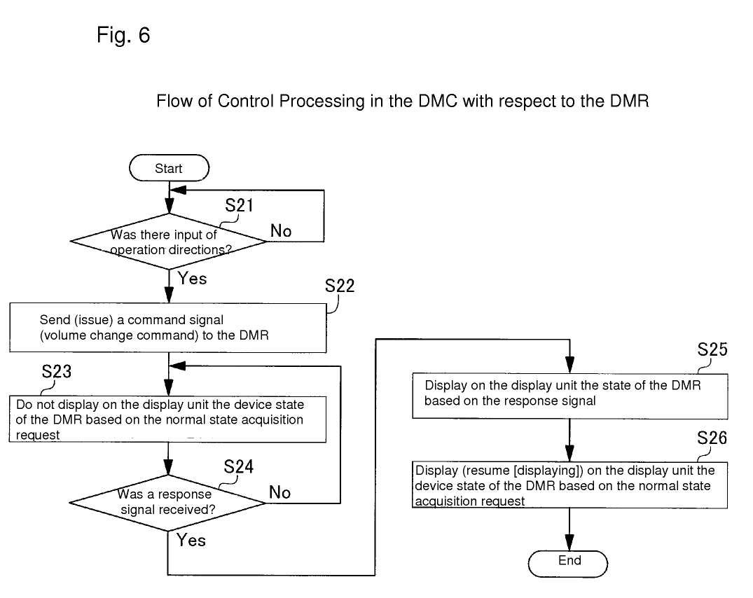

Next, a second preferred embodiment will be described with reference to FIG. 2, FIG. 5, and FIG. 6. The second preferred embodiment differs from the aforementioned first preferred embodiment in that even during the period from when a sudden (sporadic) command signal P2 is sent to the DMR 30 (see FIG. 2) based on user operation until a response signal R2 is received by the communication unit 12 of a DMC 210 (see FIG. 2), the action of periodically sending and receiving state acquisition request signals P1 and response signals R1 between the DMC 210 and the DMR 30, which is the “periodic communication control mode,” is not halted. That is, there is no “user operation mode” as in the first preferred embodiment. Note that in the figures, the same symbols as those in the first preferred embodiment are assigned to the figures as to the components with the same constitution as in the aforementioned first preferred embodiment. Note that the DMC 210 is one example of the “information terminal apparatus” and “digital media controller” of the present invention.

As is shown in FIG. 5, in the DMC 210 according to the second preferred embodiment of the present invention, as in the aforementioned first preferred embodiment, the control unit 15 (see FIG. 2) performs control such that at the time of displaying on the display unit 13 (see FIG. 2) the state of the DMR 30 that was changed based on the operation directions to the DMC 210 by the user, rather than displaying on the display unit 13 the state of the DMR 30 (the fact that the volume level was “60” before the change) based on response signals R1 that are received periodically at the respective timings of time t7 and time t8, priority is given to the act of receiving a response signal R2 from the DMR 30 at a timing of the time t9 in response to the command signal P2 and displaying on the display unit 13 the post-change state of the DMR 30 (the fact that the volume level was changed to “59”) based on the response signal R2.

Here, in the second preferred embodiment, the constitution is such that in the aforementioned control of giving priority to display actions based on the response signal R2, during the period from when the command signal P2 is sent to the DMR 30 at the timing of time t6 until the response signal R2 is received by the communication unit 12 at the timing of time t9, the control of sending state acquisition request signals P1 to the DMR 30, which is performed periodically at the respective timings of time t7 and time t8, is not halted, either. To wit, even during the sending and receiving of the sudden (sporadic) command signal P2 and response signal R2 that is done based on user operation, the “periodic communication control mode” of the exchange of state acquisition request signals P1 and response signals R1 that is performed between the DMC 210 and the DMR 30 is not halted.

Accordingly, as is shown in FIG. 5, the state of the DMR 30 based on the response signals R1 that continue to be received periodically at the respective timings of the times t3 through t8 is received even at each timing at time t10 and time t11. In this case, the post-change volume level is already confirmed as being “59” at each of the timings at time t7 and time t8, so the display at time t10 corresponding to time t7 and the display at time t11 corresponding to time t8 are both such that the volume level is displayed on the display unit 13 as being set to “59.” Thereby, in the DMC 210 as well, it is possible to clearly and appropriately display the post-change state of the DMR 30 (the fact that the volume level was changed to “59”) based on the response signal R2 that is received accompanying the user operation without being affected by the display action (the action of continuously displaying the volume level of “60”) on the display unit 13 based on the periodically received response signals R1. To wit, the periodic display actions on the display unit 13 of the DMC 210 corresponding to the response signals R1 are not commingled with the transient display action on the display unit 13 of the DMC 210 corresponding to the response signal R2, so the user is not confused by the display actions on the display unit 13 corresponding to the response signals R1, but rather can be correctly made aware of the display action of “59,” which is the result of an immediate reaction to the fact that the volume level was changed from “60” to “59.”

Next, the flow of processing of the control unit 15 of the DMC 210 when the DMC 210 according to the second preferred embodiment is used to operate the DMR 30 will be described with reference to FIG. 2, FIG. 5, and FIG. 6.

As is shown in FIG. 6, first in Step S21, the control unit 15 (see FIG. 2) determines whether or not directions to operate the DMC 210 (see FIG. 2) were input from the input unit (see FIG. 2) by the user, and also this determination is repeated until it is determined that directions by the user to operate the DMC 210 were input from the input unit 11. This determination in Step S21 is performed repeatedly at a specified timing at time t1 and thereafter in the time sequence of FIG. 5.

Here, as is shown in FIG. 5, it is assumed that at the timing of time t6, a command signal P2 (bold solid-line arrow) for lowering the volume level by just one level from the current “60” to “59” is sent from the DMC 210 to the DMR 30 based on the user operation directions. In this case, in Step S21, a determination is made (a determination of Yes) that directions to operate the DMC 10 were input from the input unit 11 by the user.

Here, in the second preferred embodiment, in Step S22, a command (command signal P2) corresponding to the operation directions accepted by the input unit 11 (operating the device so as to change the volume level of the music content) is sent (issued) to the DMR 30 at the timing of time t6 (see FIG. 6). To wit, the send and receive action of a sudden (sporadic) command signal P2 and a response signal R2 is performed in parallel based on user operation of the device without halting the “periodic communication control mode” being executed up until then.

Then, in Step S23, control is performed so as to intentionally not display on the display unit 13 of the DMC 210 the state of the DMR 30 (that the volume level is “60”) specified based on the response signals R1 received from the DMR 30 in “periodic communication control mode.” To wit, in FIG. 5, there is no display of the state of the DMR 30 corresponding to the response signals R1 received periodically from the DMR 30 at the respective timings of time t7 and time t8.

Then, in Step S24, the control unit 15 (see FIG. 2) determines whether or not a response signal R2 has been received from the DMR 30 (see FIG. 5). If it is determined in Step S24 that no response signal R2 has yet been received from the DMR 30, control returns to Step S23, and the same process is repeated thereafter.

Moreover, if it is determined in Step S24 that a response signal R2 was received, then in Step S25, control is performed so as to immediately display on the display unit 13 the state that the post-change volume level of the DMR 30 is “59” based on the response signal R2. Specifically, in FIG. 5, if the processing of Step S24 gives a determination of Yes, the response signal R2 from the DMR 30 in response to the command signal P2 is received at a timing of the time t9, and the fact that the volume level is “59” is displayed on the display unit 13 based on the response signal R2 along with the processing of Step S25.

Afterward, in Step S26, the display of the state based on the “periodic communication control mode” is resumed (restored). Accordingly, the volume level “59” based on the response signal R1 responding to the state acquisition request signal P1 sent at the timing of time t10 is displayed on the display unit 13 at the timing of time t12, and also this communication control (“periodic communication control mode”) is repeated thereafter. Thus, this control in the DMC 210 is terminated.

Note that the remaining constitution of the DMC 210 according to the second preferred embodiment is the same as the constitution of the DMC 10 according to the aforementioned first preferred embodiment.

In the second preferred embodiment, as was described above, by making the constitution so as not to halt the “periodic communication control mode,” which is the action of periodically sending and receiving between the DMC 210 and the DMR 30, even during the period of the action of sending and receiving a command signal P2 and a response signal R2 based on user operation, there is no need to perform the switching control from “periodic communication control mode” to “user operation mode” such as that in the first preferred embodiment or the switching control from “user operation mode” to “periodic communication control mode” every time the user operates the device. Therefore, the processing load on the control unit 15 can be reduced by that amount. Note that the other effects of the second preferred embodiment are the same as the effects of the aforementioned first preferred embodiment.

### Third Preferred Embodiment

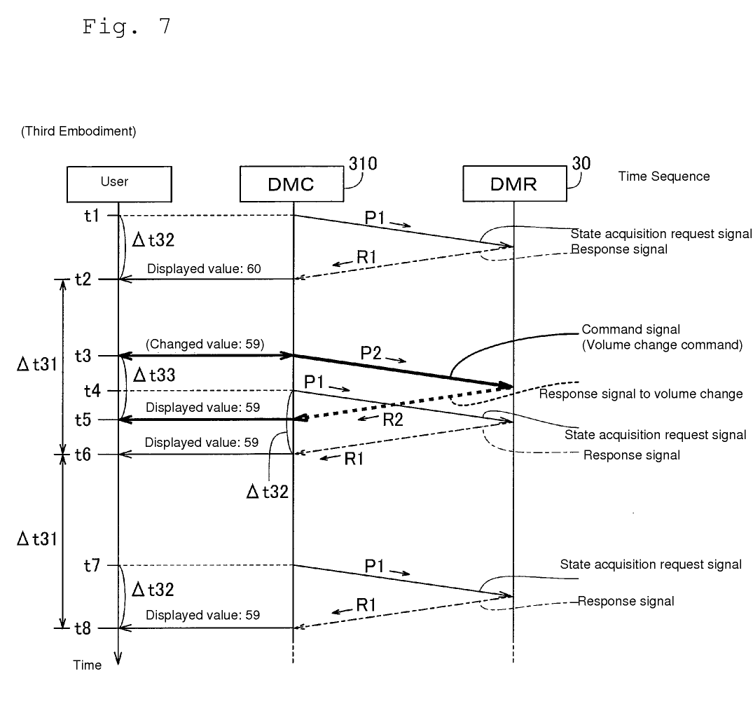

Next, a third preferred embodiment will be described with reference to FIG. 2 and FIG. 7. The third preferred embodiment differs from the aforementioned first and second preferred embodiments in that by adjusting the reception intervals of the response signals R1 that are periodically received by the communication unit 12 of a DMC 310, control is performed so as to display on the display unit 13 the post-change state of the DMR 30 based on a response signal R2 without being disturbed by the action of displaying on the display unit the state of the DMR 30 based on the response signals R1. Note that in the figures, the same symbols as those in the first preferred embodiment are assigned to the figures as to the components with the same constitution as in the aforementioned first preferred embodiment. Note that the DMC 310 is one example of the “information terminal apparatus” and “digital media controller” of the present invention.

As is shown in FIG. 7, in the home network 100 using the DMC 310 according to the third preferred embodiment of the present invention, in the same manner as in the case of the aforementioned first preferred embodiment, the constitution is such that state acquisition request signals P1 (solid-line arrows) are sent from the communication unit 12 (see FIG. 2) of the DMC 310 to the DMR 30 at specified time intervals (for example, time t4−time t1), and also response signals R1 (one-dot chain arrows) are received by the communication unit 12, and thus one round-trip of communications is repeated periodically. Note that one round-trip of communications accompanying the sending and receiving of a state acquisition request signal P1 and a response signal R1 is performed at each of the timings at time t1, time t4, and time t7. Accordingly, the reception interval Δt31 of the response signals R1 during each period of communication control becomes Δt31=time t6−time t2 and Δt31=time t8−time t6. Note that the reception interval Δt31 is one example of the “second length of time” of the present invention.

Meanwhile, the response time Δt32 required for one round-trip of communications accompanying the sending and receiving of the state acquisition request signal P1 and the response signal R1 performed at the timing of time t1 is Δt32=time t2−time t1. In addition, the response time Δt32 required for one round-trip of communications accompanying the sending and receiving of the state acquisition request signal P1 and the response signal R1 performed at the timing of time t4 is Δt32=time t6−time t4. Similarly, the response time Δt32 required for one round-trip of communications accompanying the sending and receiving of the state acquisition request signal P1 and the response signal R1 performed at the timing of time t7 is Δt32=time t8−time t7. Furthermore, the response time Δt33 required for one round-trip of communications accompanying the sending and receiving of the command signal P2 and the response signal R2 performed at the timing of time t3 is Δt33=time t5−time t3. Here, the response time Δt32 and the response time Δt33 are substantially equal. Note that the response time Δt32 and the response time Δt33 are examples of the “first length of time” of the present invention.

Here, in the third preferred embodiment, the reception interval Δt31 of the response signals R1 periodically received by the communication unit 12 is set so as to be sufficiently longer than the response time Δt32 from when a state acquisition request signal P1 is sent to the DMR 30 until a response signal R1 is received by the communication unit 12 and the response time Δt33 from when a command signal P2 is sent to the DMR 30 based on operation directions by the user until a response signal R2 is received by the communication unit 12 (Δt31>>Δt32 and Δt31>>Δt33). Moreover, the constitution is such that the reception interval Δt31 is secured so as to fit the response time Δt33 from when the command signal P2 by the user is sent to the DMR 30 until the response signal R2 is received by the communication unit 12 completely within the response time Δt31, thereby performing control so as to display on the display unit the post-change state of the DMR 30 based on the response signal R2 without being disturbed by the action of displaying on the display unit 13 the state of the DMR 30 based on the response signal R1. Note that the control described here is one example of the “second control” of the present invention.

In other words, in the third preferred embodiment, as is shown in FIG. 7, the constitution is such that the response time Δt33 required for the reception of the response signal R2 based on user operations is sufficiently short in comparison to the reception interval Δt31 of the response signals R1 so as to fit within this reception interval Δt31, so even if the state of the DMR 30 should change accompanying user operation and the necessity should arise to receive the response signal R2 containing the results of this change, it is possible to receive the response signal R2 from the DMR 30 by taking effective use of the time band within the reception interval Δt31 during which no response signal R1 is received (the time band after time t2 until time t6 is reached) and to reliably display on the display unit 13 of the DMC 310 the results of the change (the fact that the volume level was changed to “59”) based on the response signal R2. Consequently, at the time of displaying on the display unit 13 of the DMC 310 the post-change state of the DMR (the fact that the volume level was changed to “59”) based on operation directions to the DMC 310 by the user, the control unit 15 performs control so as to display on the display unit 13 of the DMC 310 the post-change state of the DMR 30 based on the response signal R2 without being disturbed by the action of displaying on the display unit 13 of the DMC 310 the state of the DMR 30 based on any response signal R1 due to periodic communications (the action of displaying the fact that the volume level was “60” before the change).

Note that with regard to how much longer the reception interval Δt31 should be secured than the response time Δt33, this is decided appropriately based on the communication control specifications between the DMC 310 and the DMR 30 in accordance with the DLNA Guidelines. In this case, in the communication control specifications in accordance with the DLNA Guidelines, it is preferable to set the reception interval Δt31 as much longer than the response time Δt33 as possible. This makes it possible to increase the probability as high as possible that, within the time band indicated by the reception interval Δt31 as from when the one-previous response signal R1 is received until the next response signal R1 is received, the response signal R2 from the DMR 30 will be received, and the results of the change based on the response signal R2 will be displayed on the display unit 13 of the DMC 310.

In addition, regarding the flow of processing of the control unit 15 when the DMC 310 in the third preferred embodiment is used to operate the DMR 30, first, over a time interval (reception interval) of the time Δt31 (see FIG. 7), communication control in which a state acquisition request signal P1 is sent from the communication unit 12 (see FIG. 2) of the DMC 310 (see FIG. 7) to the DMR 30 (see FIG. 7) and also a response signal R1 is received by the communication unit 12 is repeated periodically. In the midst of this state continuing, communication control (response time Δt33) in which a command signal P2 for changing the volume level based on user operation directions is sent from the DMC 310 to the DMR 30 and also a response signal R2 is received by the communication unit 12 is performed sporadically. This is provided, however, that the reception interval Δt31 is sufficiently longer than the response time Δt33, so the reception of the response signal R2 will be done within the time band in the reception interval Δt31 during which no response signal R1 is received (the time band after time t2 until time t6 is reached in FIG. 7).

Note that the remaining constitution of the DMC 310 according to the third preferred embodiment is the same as the constitution of the DMC 10 according to the aforementioned first preferred embodiment.

In the third preferred embodiment, as was described above, the constitution is such that the reception interval Δt31 of the response signals R1 periodically received by the communication unit 12 is a reception interval that is sufficiently longer than the response time Δt32 from when a state acquisition request signal P1 is sent to the DMR 30 until a response signal R1 is received by the communication unit 12 and also the response time Δt33 from when a command signal P2 based on user operation directions is sent to the DMR 30 until a response signal R2 is received by the communication unit 12, and the reception interval is secured such that the response time Δt33 from when a command signal P2 by the user is sent to the DMR 30 until a response signal R2 is received by the communication unit 12 is kept within the reception interval Δt31, thereby performing control such that the post-change state of the DMR 30 is displayed on the display unit 13 based on the response signal R2 without being disturbed by the action of displaying on the display unit 13 the state of the DMR 30 based on any response signal R1. Consequently, the response time Δt33 required for reception of the response signal R2 based on user operation is sufficiently short in comparison to the reception interval of the response signals R1 that is set as the reception interval Δt31 so as to fit within the reception interval Δt31, so even if the state of the DMR 30 changes accompanying user operation and the necessity arises to receive a response signal R2 containing the content of this change (the results of the change), it is possible to receive the response signal R2 by utilizing the time band within the reception interval Δt31 during which no response signal R1 is received (the time band after time t2 until time t6 is reached) and to reliably display on the display unit 13 of the DMC 310 the content of the change (the results of the change) based on the response signal R2 on the display unit 13. Note that the other effects of the third preferred embodiment are the same as the effects of the aforementioned first preferred embodiment.

### (Modified Example of the Third Preferred Embodiment)

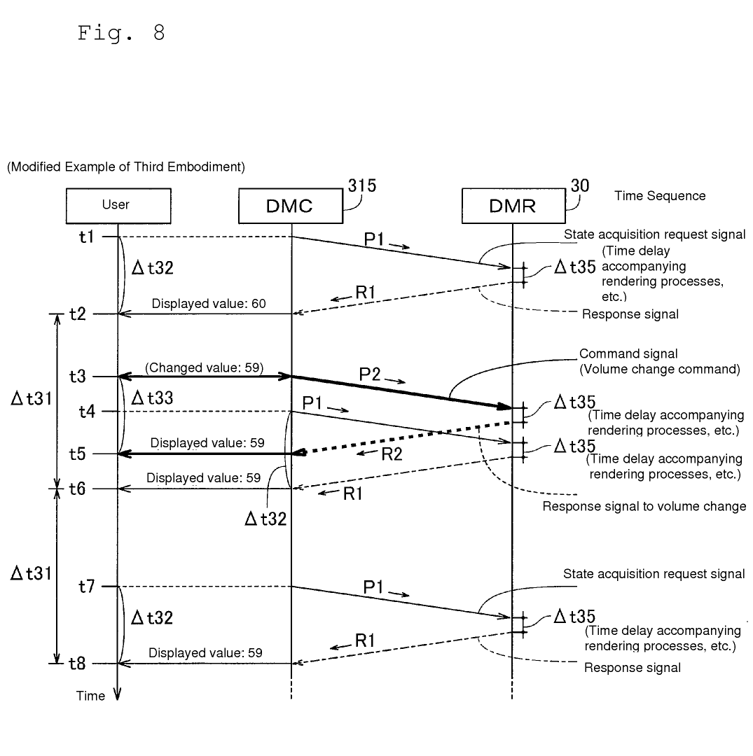

Next, a modified example of the third preferred embodiment will be described with reference to FIG. 8. In the modified example of the third preferred embodiment, an example will be described in which substantially the same type of control as in the aforementioned third preferred embodiment is performed in a state in which the communication time required for the sending and receiving of the command signal P2 or response signal R2 between a DMC 315 and the DMR 30 in the home network 100 and the processing time required for the processing of the command signal P2 or response signal R2 on the side of the DMR 30 are included in the response time Δt33. Note that in the figures, the same symbols as those in the first preferred embodiment are assigned to the figures as to the components with the same constitution as in the aforementioned first preferred embodiment. Note that the DMC 315 is one example of the “information terminal apparatus” and “digital media controller” of the present invention. Furthermore, the home network 100 is one example of the “communication network” of the present invention.

As is shown in FIG. 8, in the home network 100 using the DMC 315 according to the modified example of the third preferred embodiment of the present invention, the reception interval Δt31 of the periodically received response signals R1 is sufficiently longer than the response time Δt32 from when a state acquisition request signal P1 is sent to the DMR 30 until a response signal R1 is received by the DMC 315 and also the response time Δt33 from when a command signal P2 accompanying user operation is sent to the DMR 30 until a response signal R2 is received by the DMC 315. This point is the same as in the aforementioned third preferred embodiment.

Here, the modified example of the third preferred embodiment is constituted such that the aforementioned control is performed in a state in which the communication time required for the sending and receiving of the command signal P2 or response signal R2 between the DMC 315 and the DMR 30 in the home network 100 and the processing time required for the processing of the command signal P2 or response signal R2 on the side of the DMR 30 are included in the response time Δt33. To wit, as is shown in FIG. 8, the reception interval Δt31 of the response signals R1 received periodically by the communication unit 12 is set such that Δt31>>Δt33 in a state in which the degree of congestion of the communication state and a time Δt35 required for rendering processing within the DMR 30 are included in the response time Δt33 required for one round-trip of communications in which a command signal P2 is sent at the timing of the time t3 and a response signal R2 is received at the timing of the time t5. Thus, the reception interval Δt31 is set so as to be longer than the response time Δt33 that takes into consideration the processing capacity of the DMR 30 in the environment in which the home network 100 is constructed, so even with such a response time Δt33, it can be reliably kept within the reception interval Δt31.

Note that the remaining constitution of the DMC 315 according to the modified example of the third preferred embodiment is the same as the constitution of the DMC 310 according to the aforementioned third preferred embodiment.

As was described above, the modified example of the third preferred embodiment is constituted such that the home network 100 is constructed of the DMC 315 and the DMR 30, and the reception interval Δt31 is set so as to be sufficiently longer than the response time Δt33 which includes the communication time required for the sending and receiving of the command signal P2 or response signal R2 between the DMC 315 and the DMR 30 in the home network 100 and the processing time required for the processing of the command signal P2 or response signal R2 on the side of the DMR 30. Consequently, because the reception interval Δt31 is set so as to be longer than the response time Δt33 that takes into consideration of the processing capacity of the DMR 30 in the environment in which the home network 100 is constructed, even with such a response time Δt33, it can be reliably kept within the reception interval Δt31. Accordingly, even if a small amount of delay occurs in the timing at which the response signal R2 is received due to the processing capacity of the DMR 30, it is possible to reliably display on the display unit 13 of the DMC 315 the content of the change (the results of the change) based on the received response signal R2 on the display unit 13 without being disturbed by the action of displaying on the display unit 13 the state of the DMR 30 based on any response signal R1. Note that the other effects of the modified example of the third preferred embodiment are the same as the effects of the aforementioned third preferred embodiment.

Note that the preferred embodiments disclosed herein merely constitute illustrative examples in all respects and should be considered to be nonrestrictive. The scope of the present invention is indicated not by the description of the aforementioned preferred embodiments but rather by the scope of the patent claims, and includes all modifications with an equivalent meaning to the scope of the patent claims and within the scope of the patent claims.

For instance, in the aforementioned first through third preferred embodiments and the modified example of the third preferred embodiment, examples are shown in which the system is constituted such that by performing either control (first control) which gives priority to the action of receiving from the DMR 30 a response signal R2 responding to a command signal P2 and displaying on the display unit the post-change state of the DMR 30 based on the response signal R2 over displaying on the display unit 13 the state of the DMR 30 based on periodically received response signals R1 or control (second control) which adjusts the reception interval of the response signals R1 periodically received by the communication unit, control is performed so as to display on the display unit 13 the post-change state of the DMR 30 based on the response signal R2 without being disturbed by the action of displaying on the display unit 13 the state of the DMR 30 based on the response signals R1. However, the present invention is not limited to this. Specifically, it is also possible to combine both the aforementioned control (first control) which gives priority to the display action based on the response signal R2 and the control (second control) which adjusts the reception interval.

In addition, in the aforementioned first through third preferred embodiments and the modified example of the third preferred embodiment, examples are shown in which a home network 100 is constituted as a minimum unit by illustrating only a single DMS 20 and a single DMR 30 with respect to a single DMC (digital media controller), but the present invention is not limited to this. Specifically, a plurality of DMSs 20 and a plurality of DMRs 30 may be connected to an access point 90. Then, the constitution may be such that the control of the present invention is applied between the single DMC (digital media controller) and the plurality of DMRs 30 in this state.

Furthermore, in the aforementioned first through third preferred embodiments and the modified example of the third preferred embodiment, examples are shown in which a portable information terminal (smartphone) is used for the DMC 10 as one example of the “information terminal apparatus” of the present invention, while a digital television set is used for the DMR 30 as one example of the “device to be operated” of the present invention, but the present invention is not limited to this. For example, an information terminal apparatus (electronic device) other than the portable information terminal (smartphone) may also be used for the “information terminal apparatus” of the present invention. Moreover, an electronic device other than the digital television set may also be used for the “device to be operated” of the present invention.

In addition, in the aforementioned first through third preferred embodiments and the modified example of the third preferred embodiment, examples are shown in which the home network 100 is constituted using the DMC 10, DMS 20, and DMR 30 as the DLNA Certified™ devices that have received device certification by the DLNA, but the present invention is not limited to this. Specifically, when a communication network is constructed from an “information terminal apparatus” and a “device to be operated” provided with a communication function in accordance with communication standards (guidelines) other than those of the DLNA Certified™ devices, the present invention may also be applied to control of communications between the “information terminal apparatus” and the “device to be operated” on this communication network.

Furthermore, in the aforementioned first and second preferred embodiments, for the purpose of illustration, the control process of the control unit 15 when the DMC (digital media controller) is used to operate the DMR (digital media renderer) is described using a flow-driven-type flowchart in which processing is performed in order along the process flow, but the present invention is not limited to this. In the present invention, it is also possible to perform the control process of the control unit 15 by means of an event-driven-type processing in which processing is performed in event units. In this case, the processing may be performed completely by an event-driven-type or by a combination of even-driven and flow-driven types.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2. An information terminal apparatus comprising:
a communication unit which periodically transmits a state acquisition request signal for acquiring the state of a device to be operated and also periodically receives a first response signal from said device to be operated in response to said state acquisition request signal and also which transmits a command signal to said device to be operated based on the operation directions of the user and also receives a second response signal from said device to be operated in response to said command signal;
a display unit which displays the state of said device to be operated based on each of said first response signals and said second response signal received by said communication unit; and
a control unit which, at the time of displaying on said display unit the state of said device to be operated that was changed based on said operation directions by the user, performs control such that the state of said device to be operated after the change is displayed on said display unit based on said second response signal without being disturbed by the action of displaying on said display unit the state of said device to be operated based on said first response signal.

3. The information terminal apparatus according to claim 2, wherein said control unit is constituted so as to perform a first control which gives priority to receiving said second response signal from said device to be operated in response to said command signal and also to displaying on said display unit the post-change state of said device to be operated based on said second response signal over displaying on said display unit the state of said device to be operated based on said periodically received first response signal, thereby performing control such that the post-change state of said device to be operated is displayed on said display unit based on said second response signal without being disturbed by the action of displaying on said display unit the state of said device to be operated based on said first response signal.

4. The information terminal apparatus according to claim 2, wherein said the control unit is constituted so as to perform a second control which adjusts the reception interval of said first response signals that are periodically received by said communication unit rather than displaying on said display unit the state of said device to be operated based on said periodically received first response signal, thereby performing control such that the post-change state of said device to be operated is displayed on said display unit based on said second response signal without being disturbed by the action of displaying on said display unit the state of said device to be operated based on said first response signal.

5. The information terminal apparatus according to claim 3, wherein said first control includes control such that the post-change state of said device to be operated is displayed on said display unit based on said second response signal without being disturbed by the action of displaying on said display unit the state of said device to be operated based on said first response signal by preventing the state of said device to be operated based on said periodically received first response signal from being displayed on said display unit during the period from when said command signal is sent to said device to be operated until said second response signal is received by said communication unit.

6. The information terminal apparatus according to claim 5, wherein said first control includes control such that the state of said device to be operated based on said periodically received first response signal is prevented from being displayed on said display unit by halting the control of sending any of said state acquisition request signals to said device to be operated during the period from when said command signal is sent to said device to be operated until said second response signal is received by said communication unit.

7. The information terminal apparatus according to claim 4, wherein the reception interval of said first response signals periodically received by said communication unit is a reception interval of a second length of time which is longer than a first length of time as the response time from when any of said state acquisition request signals is sent to said device to be operated until the corresponding one of said first response signals is received by said communication unit and also as the response time from when said command signal based on said operation directions by the user is sent to said device to be operated until said second response signal is received by said communication unit, and
said second control includes control so as to display on said display unit the post-change state of said device to be operated based on said second response signal without being disturbed by the action of displaying on said display unit the state of said device to be operated based on said first response signal by securing said reception interval such that said first length of time from when said command signal by the user is sent to said device to be operated until said second response signal is received by said communication unit is kept within said second length of time.

8. The information terminal apparatus according to claim 7, wherein the constitution is such that a communication network is constructed by said information terminal apparatus and said device to be operated, and
said second length of time as said reception interval is set so as to be longer than said first length of time which includes the communication time required for the sending and receiving of said command signal or said second response signal between said information terminal apparatus and said device to be operated in said communication network and the processing time required for the processing of said command signal or said second response signal on the side of said device to be operated.

9. The information terminal apparatus according to claim 2, wherein said control unit is constituted so as to perform control such that at the time of displaying on said display unit the state of at least the audio volume, the audio quality, or the video brightness of said device to be operated that was changed based on said operation directions by the user, at least the audio volume, the audio quality, or the video brightness of said device to be operated after the change is displayed on said display unit based on said second response signal without being disturbed by the action of displaying on said display unit the state of at least the audio volume, the audio quality, or the video brightness of said device to be operated based on said first response signal.

10. The information terminal apparatus according to claim 2, wherein said information terminal apparatus and said device to be operated are a digital media controller and a digital media renderer, respectively, each of which has received device certification by the DLNA and which can recognize the other by performing mutual communications via the home network, and
said control unit is constituted so as to perform control such that at the time of displaying on said display unit the state of said digital media renderer that was changed based on the operation directions of said digital media controller by the user, the state of said digital media renderer after the change is displayed on said display unit based on said second response signal without being disturbed by the action of displaying on said display unit of said digital media controller the state of said digital media renderer based on said first response signal.
